(19) United States
(12) Patent Application Publication
(10) Pub. No.: US 2021/0114710 A1
(43) Pub. Date: Apr. 22, 2021

(54) UNMANNED AERIAL VEHICLE AND ANTENNA THEREOF

(71) Applicant: SZ DJI TECHNOLOGY CO., LTD., Shenzhen (CN)

(72) Inventor: Jianping WEI, Shenzhen (CN)

(21) Appl. No.: 17/116,557

(22) Filed: Dec. 9, 2020

Related U.S. Application Data
(63) Continuation of application No. PCT/CN2018/092469, filed on Jun. 22, 2018.

(51) Int. Cl. B64C 1/36; H01Q 5/371; H01Q 1/28; H01Q 1/48; B64C 39/02

(52) U.S. Cl. CPC B64C 1/36; H01Q 5/371; H04N 5/2253; H01Q 1/48; B64C 39/024; H01Q 1/28

(57) ABSTRACT

A UAV includes a frame, and multiple propelling devices, a flight control system, an image capturing device, and an antenna that are provided at the frame. The flight control system communicates with the propelling devices and controls the propelling devices to provide power for flight. The antenna includes two oppositely arranged antenna assemblies. Each antenna assembly includes a feed band, and an oscillator including a first frequency band branch, a second frequency band branch, and a third frequency band branch arranged side by side on a side of the feed band. The second frequency band branch is between the first frequency band branch and the third frequency band branch. The second frequency band branch is shorter than the first frequency band branch but longer than the third frequency band branch. The first frequency band branch includes a main body and a bending part at an end of the main body.

### CROSS-REFERENCE TO RELATED APPLICATION

This application is a continuation of International Application No. PCT/CN2018/092469, filed on Jun. 22, 2018, the entire content of which is incorporated herein by reference.

### TECHNICAL FIELD

The present disclosure relates to the technical field of antennas for unmanned aerial vehicles (UAVs) and, more particularly, to a UAV and an antenna thereof.

### BACKGROUND

Omnidirectional requirements become higher for antennas used by unmanned aerial vehicles (UAVs) or other image transmission devices, and there are more and more communication links, and thus it may be difficult for dual-frequency antennas to meet the existing communication requirements. Moreover, in order to ensure the quality of signal transmission, the antennas of UAVs of conventional designs may have large volume. However, in the field of UAVs, the large volume of the antennas may often affect the design of UAVs and is not conducive to the miniaturization of UAVs.

### SUMMARY

In accordance with the disclosure, there is provided an antenna for an unmanned aerial vehicle (UAV). The antenna includes a first antenna assembly and a second antenna assembly arranged opposite to each other. Each of the first antenna assembly and the second antenna assembly includes a feed band and at least one oscillator. The Oscillator includes a first frequency band branch, a second frequency band branch, and a third frequency band branch. The first frequency band branch, the second frequency band branch, and the third frequency band branch are arranged side by side on a side of the feed band. The first frequency band branch and the third frequency band branch are disposes at two opposite sides of the second frequency band branch, respectively. A length of the first frequency band branch is greater than a length of the second frequency band branch. The length of the second frequency band branch is greater than a length of the third frequency band branch. The first frequency band branch includes a main body and a bending part provided at an end of the main body.

### BRIEF DESCRIPTION OF THE DRAWINGS

FIG. 1 is a perspective view of an unmanned aerial vehicle (UAV) according to some embodiments of the present disclosure.

FIG. 2 is a schematic block diagram of the UAV shown in FIG. 1.

FIG. 3 is a structural diagram of an antenna of a UAV according to some embodiments of the present disclosure.

FIG. 4 is a structural diagram of an antenna of a UAV according to some other embodiments of the present disclosure.

FIG. 5 is a structural diagram of an antenna of a UAV according to some other embodiments of the present disclosure.

FIG. 6 is an actual measured gain pattern of the antenna shown in FIG. 3 in a low frequency band at Phi=0 degrees.

FIG. 7 is an actual measured gain pattern of the antenna shown in FIG. 3 in a low frequency band at Phi=90 degrees.

FIG. 8 is an actual measured gain pattern of the antenna shown in FIG. 3 in a low frequency band at Theta=90 degrees.

FIG. 9 is an actual measured gain pattern of the antenna shown in FIG. 3 in an intermediate frequency band at Phi=0 degrees.

FIG. 10 is an actual measured gain pattern of the antenna shown in FIG. 3 in an intermediate frequency band at Phi=90 degrees.

FIG. 11 is an actual measured gain pattern of the antenna shown in FIG. 3 in an intermediate frequency band at Theta=90 degrees.

FIG. 12 is an actual measured gain pattern of the antenna shown in FIG. 3 in a high frequency band at Phi=0 degrees.

FIG. 13 is an actual measured gain pattern of the antenna shown in FIG. 3 in a high frequency band at Phi=90 degrees.

FIG. 14 is an actual measured gain pattern of the antenna shown in FIG. 3 in a high frequency band at Theta=90 degrees.

REFERENCE NUMERALS FOR MAIN COMPONENTS: 10, UAV; 11, center body; 12, arm; 13, standing support; 14, propelling device; 15, flight control system; 16, image capturing device; 20, antenna; 21, first antenna assembly; 211, first oscillator; 212, second oscillator; 22, second antenna assembly; 221, third oscillator; 222, fourth oscillator; 23, feed band; 231, first feed band; 232. second feed band; 24, oscillator; 241, first frequency band branch; 242, second frequency band branch; 243, third frequency band branch; 244, main body; 245, bending part; 246, first backward bending arm; 247, second backward bending arm; 28, feed structure; 281, feed member; 282, grounding member; 291, first feed guide; 292, second feed guide; 293, conductive member.

### DETAILED DESCRIPTION OF THE EMBODIMENTS

Although the present disclosure can be implemented in different forms of embodiments, some but not all of the embodiments of the present disclosure are shown in the drawings and described in detail in this specification. This specification should be regarded as exemplary description of the principle of the present disclosure and is not intended to limit the scope of present disclosure.

Therefore, a feature indicated in this specification will be used to describe one of the features of an embodiment of the present disclosure, rather than to imply that each embodiment of the present disclosure must have the described feature. In addition, it should be noted that this specification describes many features. Although certain features can be combined to illustrate possible system designs, these features can also be used in other unspecified combinations. Thus, unless otherwise stated, the illustrated combinations are not intended to limit the present disclosure.

In the embodiments shown in the drawings, the directional indications (such as up, down, left, right, front, and back) used to explain the structure and movement of various elements of the present disclosure are not absolute but relative. When these elements are in the positions shown in the drawings, these descriptions are appropriate. If the positional descriptions of these elements change, the directions indicated by these directional indications may also change accordingly.

Hereinafter, some embodiments of the present disclosure will be further described in detail with reference to the accompanying drawings of this specification. In cases of no conflict, the following embodiments and features in these embodiments can be combined with each other.

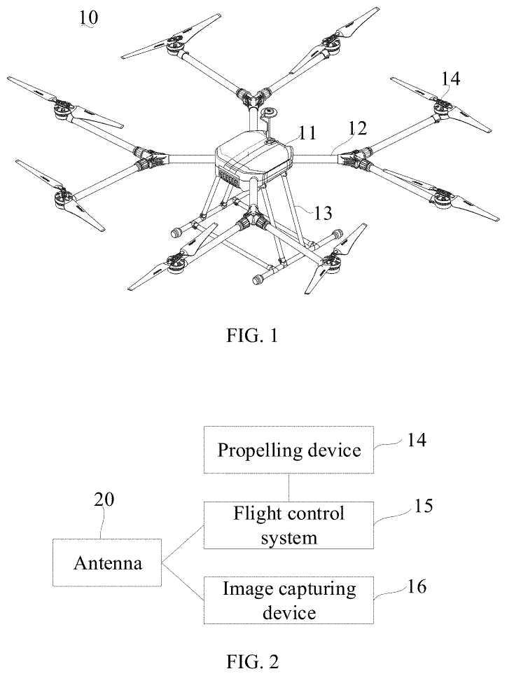

FIGS. 1 and 2 show an unmanned aerial vehicle (UAV) 10 and antenna 20 thereof. The UAV 10 includes a frame, a plurality of propelling devices 14, a flight control system 15, an image capturing device 16, and antenna 20.

As shown in FIG. 1, the frame includes a center body 11, an arm 12, and a standing support 13. The arm 12 is connected to the center body 11. The standing support 13 is connected with the center body 11 and the arm 12. In some other embodiments, the standing support 13 may be directly provided on the center body 11 or the arm 12.

The plurality of propelling devices 14 are provided on the arm 12. The propelling device 14 may be a propeller to provide power for the flight of the UAV.

The flight control system 15 is arranged on the center body 11 of the frame. The flight control system 15 is in communication connection with the plurality of propelling devices 14 and is configured to control the plurality of propelling devices 14 to provide power for flight. In some embodiments, the flight control system 15 may be configured to control speed adjustment of the plurality of propelling devices 14.

The image capturing device 16 is mounted at the center body 11 of the frame. During the flight of the UAV, the image capturing device 16 may be configured to collect image data. The image capturing device 16 may be a camera.

In some embodiments, the antenna 20 may be mounted at the standing support 13. In other embodiments, the antenna 20 may be mounted in another structure of the frame. The antenna 20 is configured to provide signal transmission for the UAV 10. The antenna 20 is in communication connection with the flight control system 15 and the image capturing device 16. The flight control system 15 may send and receive control signals from a ground control terminal through the antenna 20, and the image capturing device 16 may transmit image data to the ground control terminal through the antenna 20.

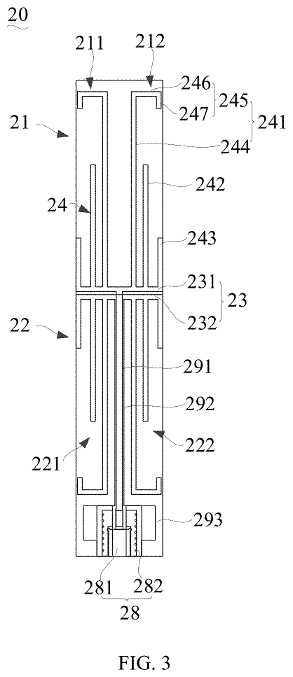

As shown in FIG. 3, the antenna 20 of the UAV includes a first antenna assembly 21 and a second antenna assembly 22. The first antenna assembly 21 and the second antenna assembly 22 are arranged opposite to each other. Each of the first antenna assembly 21 and the second antenna assembly 22 includes a feed band 23 and an oscillator 24.

The oscillator 24 includes a first frequency band branch 241, a second frequency band branch 242, and a third frequency band branch 243. The first frequency band branch 241, the second frequency band branch 242, and the third frequency band branch 243 are arranged side by side (e.g., arranged side by side) at one side of the feed band 23. The first frequency band branch 241 and the third frequency band branch 243 are arranged at two opposite sides of the second frequency band branch 242, respectively. A length of the first frequency band branch 241 is greater than a length of the second frequency band branch 242. The length of the second frequency band branch 242 is greater than a length of the third frequency band branch 243. The first frequency band branch 241 includes a main body 244 and a bending part 245 provided at an end of the main body 244.

In some embodiments, the oscillator 24 includes a first frequency band branch 241, a second frequency band branch 242, and a third frequency band branch 243, where the first frequency band branch 241, the second frequency band branch 242, and the third frequency band branch 243 correspond to signal transmission of three frequency bands, respectively. In addition, the first frequency band branch 241 is configured with the longest length and includes a bending part 245. The bending part 245 greatly reduces a length occupied by the first frequency band branch 241, thereby reducing a length of the entire antenna and reducing a space occupied by the antenna, which is beneficial to a miniaturized design of the UAV.

In some embodiments, the oscillator 24 of the first antenna assembly 21 and the oscillator 24 of the second antenna assembly 22 are arranged in mirror symmetry.

In some embodiment, each of the first antenna assembly 21 and the second antenna assembly 22 may include a single oscillator or a plurality of oscillators. The plurality of oscillators of the first antenna assembly 21 are arranged in mirror symmetry. The plurality of oscillators of the second antenna assembly 22 are arranged in mirror symmetry.

In some embodiments, each of the first antenna assembly 21 and the second antenna assembly 22 may include a plurality of oscillators. The first frequency band branches 241 of two adjacent ones of the plurality of oscillators of the first antenna assembly 21 are located at an inner side of the first antenna assembly 21, and the third frequency band branches 243 are located at an outer side of the first antenna assembly 21. The first frequency band branches 241 of two adjacent ones of the plurality of oscillators of the second antenna assembly 22 are located at an inner side of the second antenna assembly 22, and the third frequency band branches 243 are located at an outer side of the second antenna assembly 22.

In some embodiments, the first antenna assembly 21 and the second antenna assembly 22 are arranged oppositely with one on the top of the other. Each of the first antenna assembly 21 and the second antenna assembly 22 includes two oscillators. The two oscillators of the first antenna assembly 21 are arranged in mirror symmetry with the two oscillators of the second antenna assembly 22. In addition, the two oscillators of the first antenna assembly 21 are arranged in a mirror symmetry, and the two oscillators of the second antenna assembly 22 are arranged in a mirror symmetry.

The first antenna assembly 21 includes a first oscillator 211 and a second oscillator 212. The second antenna assembly 22 includes a third oscillator 221 and a fourth oscillator 222. The first oscillator 211 and the second oscillator 212 are arranged in mirror symmetry, and the third oscillator 221 and the fourth oscillator 222 are arranged in mirror symmetry. The first oscillator 211 and the third oscillator 221 are arranged in mirror symmetry. The second oscillator 212 and the fourth oscillator 222 are arranged in mirror symmetry.

In some embodiments, as shown in FIG. 3, the main body 244 of the first frequency band branch 241, the second frequency band branch 242, and the third frequency band branch 243 extend along a longitudinal direction (e.g., the vertical direction in FIG. 3) of the oscillator, and the feed band 23 extends along a transverse direction (e.g., the horizontal direction in FIG. 3) of the oscillator. The first frequency band branch 241, the second frequency band branch 242, and the third frequency band branch 243 are arranged side by side horizontally. The bending part 245 of the first frequency band branch 241 is bent toward the transverse direction of the oscillator.

The first frequency band branch 241 may be a low frequency oscillator branch. The second frequency band branch 242 may be an intermediate frequency oscillator branch. The third frequency band branch 243 may be a high frequency oscillator branch. For example, the first frequency band branch 241 may be a 1.4 GHz frequency band oscillator branch. The second frequency band branch 242 may be a 2.4 GHz frequency band oscillator branch. The third frequency band branch 243 may be a 5.8 GHz frequency band oscillator branch.

The first frequency band branch 241 of the first oscillator 211 and the first frequency band branch 241 of the second oscillator 212 are arranged adjacent to each other, and are located in the middle (e.g., an inner side) of the first antenna assembly 21. The third frequency band branch 243 of the first oscillator 211 and the third frequency band branch 243 of the second oscillator 212 are located on two opposite sides (e.g., left and right sides) of the first antenna assembly 21, respectively. For the first oscillator 211, the second frequency band branch 242 is located between the first frequency band branch 241 and the third frequency band branch 243. For the second oscillator 212, the second frequency band branch 242 is located between the first frequency band branch 241 and the third frequency band branch 243. For each of the oscillators, the first frequency band branch 241, which is the low frequency band oscillator branch, has the longest length. The first frequency band branch 241 is located in the middle of the antenna, avoiding the interference of the first frequency band branch 241 against the signals of the second frequency band branch 242 and the third frequency band branch 243 that are located on the outer side of the antenna 20.

A distance between the first frequency band branch 241 and the second frequency band branch 242 is greater than a signal interference distance therebetween, such that mutual interference of signals between the first frequency band branch 241 and the second frequency band branch 242 can be avoided.

A distance between the second frequency band branch 242 and the third frequency band branch 243 is greater than a signal interference distance therebetween, such that mutual interference of signals between the second frequency band branch 242 and the third frequency band branch 243 can be avoided.

A distance between the bending part 245 of the first frequency band branch 241 and a free end of the second frequency band branch 242 is greater than the signal interference distance between the first frequency band branch 241 and the second frequency band branch 242, such that mutual interference of signals between the bending part 245 of the first frequency band branch 241 and the second frequency band branch 242 can be avoided.

In some embodiments, the bending part 245 includes a first backward bending arm 246. The first backward bending arm 246 may be inclined at a first angle relative to the main body 244 of the first frequency band branch 241, and may be bent from the main body 244, and extended toward the outer side of the antenna 20.

A length of the first backward bending arm 246 may be less than or equal to a distance between the main body 244 of the first frequency band branch 241 and the third frequency band branch 243. The configuration of the first backward bending arm 246 does not increase a transverse size of the oscillator, but can minimize the longitudinal size (e.g., size in the vertical direction shown in FIGS. 3-5) of the oscillator as much as possible while maintaining the shortest transverse size (e.g., size in the horizontal direction shown in FIGS. 3-5) of the oscillator.

The length of the first backward bending arm 246 may be greater than or equal to the distance between the body 244 of the first frequency band branch 241 and the second frequency band branch 242. Without increasing the lateral size of the oscillator, the length of the first backward bending arm 246 may be extended as much as possible to avoid waste of space.

The first angle may be in a range from 60 degrees to 120 degrees. The first backward bending arm 246 is bent at a first angle, thereby reducing the longitudinal length of the first frequency band branch 241. For example, the first angle may be 90 degrees. That is, the first backward bending arm 246 and the main body 244 are perpendicular to each other.

The bending part 245 further includes a second backward bending arm 247 connected to an end of the first backward bending arm 246.

The second backward bending arm 247 may be inclined at a second angle relative to the first backward bending arm 246, may be bent from the end of the first backward bending arm 246, and extend toward the third frequency band branch 243. The second angle may be in a range from 60 degrees to 120 degrees. The second backward bending arm 247 is bent at a second angle, thereby reducing the transverse length of the first frequency band branch 241. For example, the second preset angle may be 90 degrees. That is, the second turning arm 247 and the first turning arm 246 are perpendicular to each other.

A length of the second backward bending arm 247 may be smaller than the distance between the end of the first backward bending arm 246 and a free end of the second frequency band branch 242, such that mutual interference of signals between the second backward bending arm 247 and the second frequency band branch 242 caused by too small distance therebetween can be avoided.

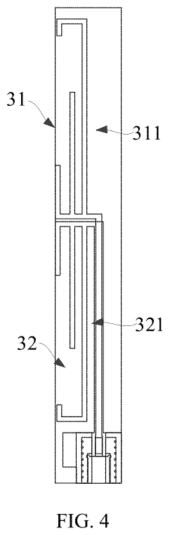

In some embodiments, as shown in FIG. 4, the first antenna assembly 31 includes an oscillator, and the second antenna assembly 32 also includes an oscillator. For example, the first antenna assembly 31 includes a first oscillator 311, and the second antenna assembly 22 includes a third oscillator 321. The first oscillator 311 and the third oscillator 321 are arranged in mirror symmetry.

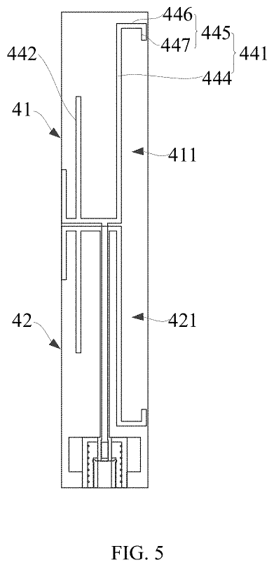

In some embodiments, as shown in FIG. 5, the first backward bending arm 446 of the first frequency band branch 441 of the first oscillator 411 can be bent away from the second frequency band branch 442, such that a longitudinal length of the first frequency band branch 441 is reduced, thereby reducing the size of the antenna.

In some embodiments, the oscillator(s) of the first antenna assembly 21 and the oscillator(s) of the second antenna assembly 22 may be centrosymmetrically distributed. For example, the first antenna assembly 21 includes a first oscillator 211, and the second antenna assembly 22 includes a fourth oscillator 222. The first oscillator 211 and the fourth oscillator 222 are centrosymmetric with respect to the center of the antenna. The antenna can achieve three-frequency omnidirectional coverage through the first oscillator 211 and the fourth oscillator 222.

In some embodiments, the first antenna assembly 21 includes a first feed band 231, and the second antenna assembly 22 includes a second feed band 232, where the first feed band 231 and the second feed band 232 are arranged adjacent to each other. The first antenna assembly 21 and the second antenna assembly 22 are arranged in close proximity to each other, so as not to occupy extra space but to minimize the longitudinal length of the antenna.

The antenna also includes a feed structure 28. The feed structure 28 is arranged on a side of the second antenna assembly 22 away from the first antenna assembly 21. The feed structure 28 may include a feed coaxial line, and the feed coaxial line includes a feed member 281 and a grounding member 282 that are coaxially arranged with each other. The grounding member 282 is located at periphery of the feed member 281. The feed band (e.g., feed band 232) of the second antenna assembly 22 is connected to the grounding member 282.

The first feed band 231 of the first antenna assembly 21 is electrically connected to the feed structure 28, and the second feed band 232 of the second antenna assembly 22 is grounded through the feed structure 28. The first antenna assembly 21 is also provided with a first feed guide 291. The first feed band 231 is electrically connected to the feed structure 28 through the first feed guide 291. In some embodiments, one terminal of the first feed guide 291 is connected to the middle of the first feed band 231. The other terminal of the first feed guide 291 is connected to the feed member 281 of the feed structure 28.

The second antenna assembly 22 is provided with a second feed guide 292. The feed band of the second antenna assembly 22 is grounded through the second feed guide 292. In some embodiments, one terminal of the second feed guide 292 is connected to the middle of the second feed band 232. A conductive member 293 is provided at the other terminal of the second feed guide 292, and the conductive member 293 is connected to the grounding member 282 of the feed structure 28.

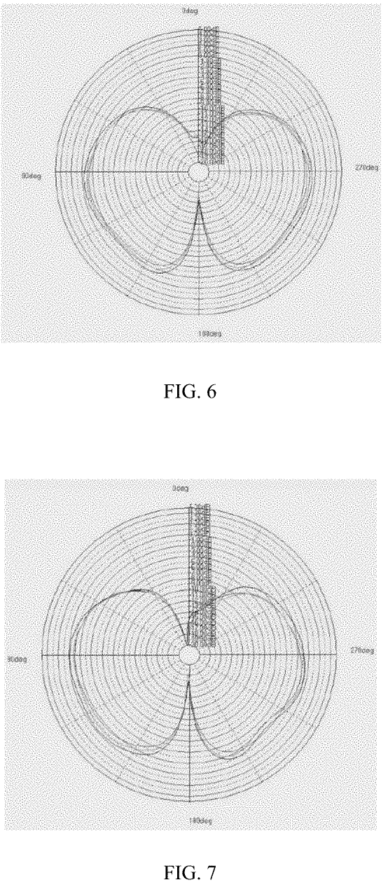

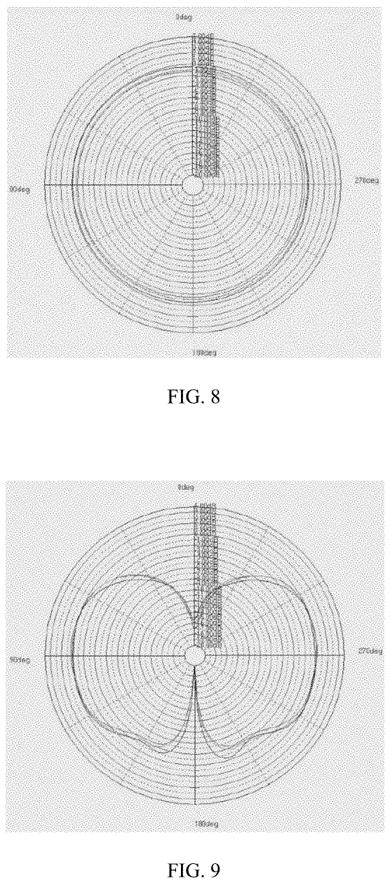

FIGS. 6-8 show the actual measured gain patterns of the antenna of the UAV according to some embodiments of the present disclosure in low frequency bands of 1400 MHz, 1420 MHz, and 1440 MHz. FIG. 6 shows three curves corresponding to low frequencies of 1400 MHz, 1420 MHz, and 1440 MHz, respectively, when Phi=0 degree. FIG. 7 shows three curves corresponding to low frequencies of 1400 MHz, 1420 MHz, and 1440 MHz, respectively, when Phi=90 degrees. FIG. 8 shows three curves corresponding to low frequencies of 1400 MHz, 1420 MHz, and 1440 MHz, respectively, when Theta=90 degrees. It can be seen from FIG. 8 that in the Theta=90 degrees cross section, the gain difference is within 2 dB, and the antenna can achieve full coverage of the low frequency band.

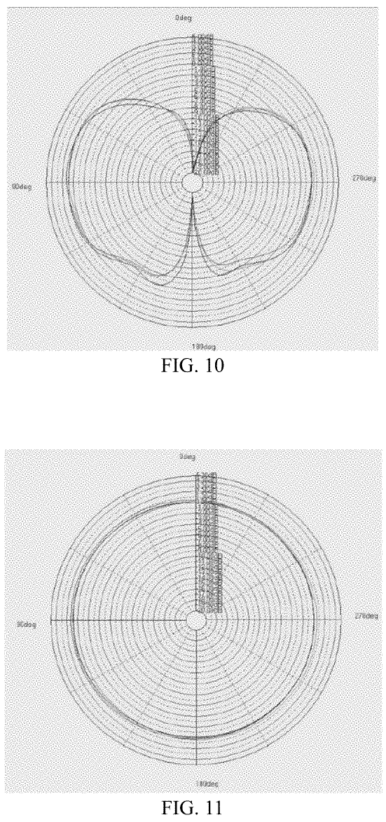

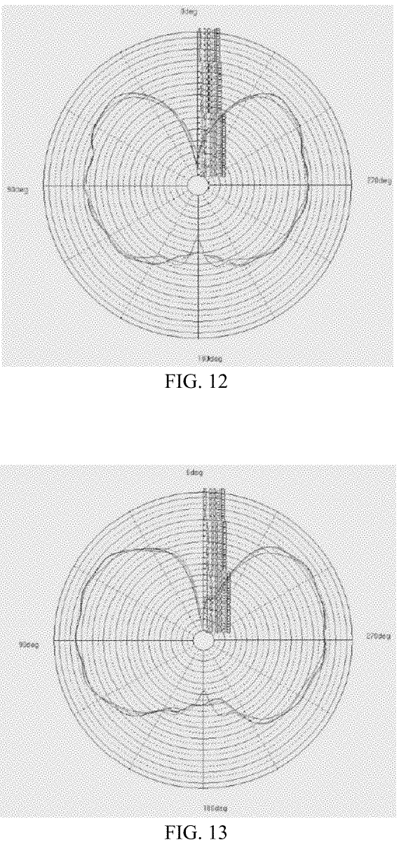

FIGS. 9-11 show the actual measured gain pattern of the antenna of the UAV according to some embodiments of the present disclosure in the frequency bands of 2400 MHz, 2450 MHz, and 2500 MHz. FIG. 9 shows three curves corresponding to intermediate frequencies of 2400 MHz, 2450 MHz, and 2500 MHz, respectively, when Phi=0 degree. FIG. 10 shows three curves corresponding to intermediate frequencies of 2400 MHz, 2450 MHz, and 2500 MHz, respectively, when Phi=90 degrees. FIG. 11 shows the three curves corresponding to intermediate frequencies of 2400 MHz, 2450 MHz, and 2500 MHz, respectively, when Theta=90 degrees. It can be seen from FIG. 10 that in the Theta=90 degrees cross section, the gain difference is within 2 dB, and the antenna can achieve full coverage of the intermediate frequency band.

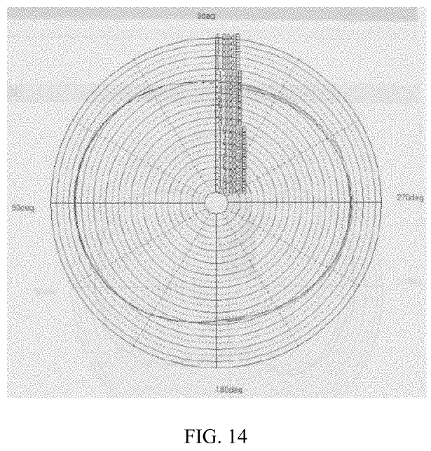

FIGS. 12-14 show the actual measured gain pattern of the antenna of the UAV according to some embodiments of the present disclosure in the frequency bands of 5700 MHz, 5750 MHz, and 5800 MHz. FIG. 12 shows three curves corresponding to high frequency of 5700 MHz, 5750 MHz, and 5800 MHz, respectively, when Phi=0 degree. FIG. 13 shows three curves corresponding to high frequency of 5700 MHz, 5750 MHz, and 5800 MHz, respectively, when Phi=90 degrees. FIG. 14 shows three curves corresponding to high frequency of 5700 MHz, 5750 MHz, and 5800 MHz, respectively, when Theta=90 degrees. It can be seen from FIG. 14 that in the Theta=90 degrees cross section, the gain difference is within 2 dB, the antenna can achieve full coverage of the high-frequency band.

The UAV consistent with the disclosure can achieve better comprehensive coverage in the low frequency, intermediate frequency, and high frequency bands through the antenna, and the antenna performance can be significantly improved. In addition, the small size of the antenna may facilitate the development of UAV miniaturization.

Although the present disclosure has been described with reference to some embodiments, it should be understood that the terms used are illustrative and exemplary rather than restrictive. Since the present disclosure can be implemented in various forms without departing from the spirit or essence of the invention, it should be understood that the above-mentioned embodiments are not limited to any of the foregoing details, but should be interpreted broadly within the spirit and scope defined by the appended claims. Therefore, all changes and modifications falling within the scope of the claims or their equivalents shall be covered by the appended claims.

What is claimed is:

1. An unmanned aerial vehicle (UAV) comprising:
a frame;
a plurality of propelling devices provided at the frame;
a flight control system provided at the frame, the flight control system being in communication connection with the plurality of propelling devices and configured to control the plurality of propelling devices to provide power for flight;
an image capturing device provided at the frame; and
an antenna provided at the frame and including:
a first antenna assembly and a second antenna assembly arranged opposite to each other, each of the first antenna assembly and the second antenna assembly including:
a feed band; and
an oscillator including a first frequency band branch, a second frequency band branch, and a third frequency band branch;
wherein:
the first frequency band branch, the second frequency band branch, and the third frequency band branch are arranged side by side on a side of the feed band;
the first frequency band branch and the third frequency band branch are disposed at two opposite sides of the second frequency band branch, respectively;
a length of the first frequency band branch is greater than a length of the second frequency band branch;
the length of the second frequency band branch is greater than a length of the third frequency band branch; and
the first frequency band branch includes a main body and a bending part provided at an end of the main body.

2. The UAV of claim 1, wherein:
the oscillator of the first antenna assembly is one of a plurality of oscillators of the first antenna assembly and the oscillator of the second antenna assembly is one of a plurality of oscillators of the second antenna assembly; and
at least one of the plurality of oscillators of the first antenna assembly or the plurality of oscillators of the second antenna assembly are arranged in mirror symmetry.

3. The UAV of claim 1, wherein:
the oscillator of the first antenna assembly is one of a plurality of oscillators of the first antenna assembly and the oscillator of the second antenna assembly is one of a plurality of oscillators of the second antenna assembly;
first frequency band branches of two adjacent ones of the plurality of oscillators of the first antenna assembly are located at an inner side of the first antenna assembly, and third frequency band branches of the first antenna assembly are located at an outer side of the first antenna assembly; and
first frequency band branches of two adjacent ones of the plurality of oscillators of the second antenna assembly are located at an inner side of the second antenna assembly; and third frequency band branches of the second antenna assembly are located at an outer side of the second antenna assembly.

4. The UAV of claim 1, wherein the oscillator of the first antenna assembly and the oscillator of the second antenna assembly are arranged in mirror symmetry or centrosymmetry with respect to each other.

5. The UAV of claim 1, wherein the feed band of the first antenna assembly and the feed band of the second antenna assembly are arranged next to each other.

6. The UAV of claim 1, further comprising:
a feed structure arranged on a side of the second antenna assembly away from the first antenna assembly;
wherein the feed band of the first antenna assembly is electrically connected to the feed structure, and the feed band of the second antenna assembly is grounded through the feed structure.

7. The UAV antenna according to claim 6, wherein the first antenna assembly further includes a feed guide, the feed band of the first antenna assembly is electrically connected to the feed structure through the feed guide of the first antenna assembly.

8. The UAV of claim 7, wherein a terminal of the feed guide of the first antenna assembly is connected to a middle of the feed band of the first antenna assembly.

9. The UAV of claim 6, wherein the second antenna assembly further includes a feed guide, the feed band of the second antenna assembly is grounded through the feed guide of the second antenna assembly.

10. The UAV of claim 9, wherein one terminal of the feed guide of the second antenna assembly is connected to a middle of the feed band of the second antenna assembly, and another terminal of the feed guide of the second antenna assembly includes a grounded conductive member.

11. The UAV of claim 6, wherein the feed structure includes a feed coaxial line, the feed coaxial line including a feed member and a grounding member coaxially arranged with each other, the grounding member being located at periphery of the feed member, and the feed band of the second antenna assembly being connected to the grounding member.

12. The UAV of claim 1, wherein:
a distance between the first frequency band branch and the second frequency band branch is greater than a signal interference distance between the first frequency band branch and the second frequency band branch;
a distance between the second frequency band branch and the third frequency band branch is greater than a signal interference distance between the second frequency band branch and the third frequency band branch; or
a distance between the bending part of the first frequency band branch and a free end of the second frequency band branch is greater than the signal interference distance between the first frequency band branch and the second frequency band branch.

13. The UAV of claim 1, wherein the bending part includes a backward bending arm inclined at an angle relative to the main body of the first frequency band branch, bending from the main body of the first frequency band branch, and extending toward an outer side of the antenna.

14. The UAV of claim 13, wherein a length of the backward bending arm is:
less than or equal to a distance between the main body of the first frequency band branch and the third frequency band branch; or
greater than or equal to a distance between the main body of the first frequency band branch and the second frequency band branch.

15. The UAV of claim 13, wherein the angle is in a range from 60 degrees to 120 degrees.

16. The UAV of claim 13, wherein:
the backward bending arm is a first backward bending arm and the angle is a first angle; and
the bending part further includes a second backward bending arm connected to an end of the first backward bending arm and inclined at a second angle relative to the first backward bending arm, bending from the first backward bending arm, and extending toward the third frequency band branch.

17. The UAV of claim 16, wherein the second angle is in a range from 60 degrees to 120 degrees.

18. The UAV of claim 16, wherein a length of the second backward bending arm is less than a length between the end of the first backward bending arm and a free end of the second frequency band branch.

19. The UAV of claim 1, wherein:
the first frequency band branch includes a 1.4 GHz frequency band oscillator branch;
the second frequency band branch includes a 2.4 GHz frequency band oscillator branch; and
the third frequency band branch includes a 5.8 GHz frequency band oscillator branch.

20. The UAV of claim 1, wherein the second frequency band branch is located between the first frequency band branch and the third frequency band branch.
